(19) United States
(12) Patent Application Publication
(10) Pub. No.: US 2007/0241154 A1
(43) Pub. Date: Oct. 18, 2007

(54) Multi-positionable caddy and organizer system

(76) Inventors: Kenneth Lee Potts, Solana Beach, CA (US); Debra Lee Potts, Solana Beach, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/799,837

(22) Filed: May 2, 2007

Related U.S. Application Data
(63) Continuation-in-part of application No. 10/881,034, filed on Jun. 29, 2004.

(51) Int. Cl. B60R 11/00

(52) U.S. Cl. 224/539

(57) ABSTRACT

A caddy device for carrying and organizing articles being transported in a vehicle. The caddy is user-configurable to one or multiple individual compartments for optimizing their dimensions for carrying, holding and organizing articles such as filled shopping bags or food and drinks. Employing multiple dividers the device may be deployed to numerous different positions to adjust the compartment size. An optional cooler bag for transport of cold items is also engagable within the compartments.

### BACKGROUND OF THE INVENTION

This application is a continuation-in-part of pending U.S. application Ser. No. 10/881,034 filed Jun. 29, 2004. The present invention relates to a caddy and organizer system and pertains more particularly to arrangements for improved collapsibility, positionability, and engagement of shopping caddies, shopping bags, beverage containers and various other items to be organized.

### DISCUSSION OF PRIOR ART

Groceries are typically bagged at the checkout counter in a plastic bag or a collapsible paper bag. The paper and plastic bags are generally considered to be disposable items. Alternatively, reusable canvas bags are sometimes used to transport groceries. Any of the various types of grocery bags are conventionally transported from the store in a cargo area of a motor vehicle, such as the trunk of a car or anywhere on the floor of a vehicle such as a van, a minivan, or a sports utility vehicle. In addition to groceries, other items are frequently transported in vehicles, such as picnic items, sports equipment, nursery plants and beverage containers.

However, it has been conventionally recognized that bags can tip, shift and spill. In response to this problem, holders (or caddies) have been used to secure grocery bags and other transported items in motor vehicles. However, possibly due in part to the expense and/or cumbersomeness of conventional shopping caddies, these devices have not been widely used.

U.S. Pat. No. 4,226,348 to Dottor et al. discloses a grocery bag holder with a rigid bottom mat member. The upstanding sides of the grocery bag holder disclosed in this patent can be folded down or collapsed down to lie flat along the bottom mat. However, the bottom mat itself is not collapsible.

The public's ever-increasing reliance on transportation by private motor vehicle requires more and more people to be in their motor vehicles for greater periods of time. Commuting times are increasing, as well as activities and responsibilities of family members. Associated personal items, such as food, beverages, cosmetics, entertainment equipment, and paper often become disorganized and scattered about the vehicle, especially when it is in motion. Vehicle accidents often occur when a driver becomes distracted while attempting to fetch one of these items from the floor of the vehicle, especially in vans of any size.

Several vehicle organizer systems are known. In general, they contain one or more compartments for containing particular items. Some systems are collapsible. However, their versatility is usually limited in one or more different ways.

### SUMMARY OF THE INVENTION

The present invention relates to improved designs for shopping caddies and organizers for various articles in moving vehicles. At least some embodiments of the present invention provide a shopping caddy system which is more adjustable, lighter in weight, more easily portable, and less expensive than conventional shopping caddy systems. The organizer system of the present invention can be adapted to a variety of configurations for holding articles of various sizes, and is collapsible for storage and transport. The system is adaptable to a variety of uses, for example, vehicle, home, and recreational uses.

In some embodiments of the present invention, upstanding, somewhat rigid end panels can be rotated or folded downward against an intermediate divider or the bottom panel of the organizer. This gives the bottom of the caddy additional rigidity and a larger effective base when a compartment formed between the end panel and the intermediate divider is empty of bags.

In some embodiments of the present invention, the caddy can be collapsed so that its end panels and intermediate dividers form a compact stack, having a relatively small “footprint” corresponding to the length and width of the end panels. This is an advantage over collapsible caddies with rigid bottom panels because the “footprint” for these caddies in the collapsed position would correspond to the length and width of the rigid and relatively large bottom panel. On the other hand, the end-to-end collapsible embodiments of the present invention work especially well in conjunction with the rigid downward-folding end panels described above.

According to a first aspect of the invention, a device is provided for organizing or holding shopping articles in an upright position. The device includes a rigid first end panel, a rigid second end panel, a rigid first divider panel, a rigid second divider panel, and a rigid center divider panel positioned between the first divider and second divider panels and approximately parallel thereto. Although many preferred embodiments of “rigid” panels will be capable of some degree of elastic deformation as will be discussed in detail below, they are to be distinguished from pliable fabric, such as nylon or other fabric, which is not herein considered to be rigid.

A pliable base is connected to at least side edges of the first and second end panels, the first and second divider panels, and the center divider panel. The base is structured to constrain the first end panel, the second end panel, the first divider panel, the second divider panel and the center divider panel relative to each other so that the distance between the panels is substantially the same.

The base also includes a first panel between the first end panel and the first divider panel, a second panel between the first divider panel and the center divider panel, a third panel between the center divider panel and the second divider panel, and a fourth panel between the second divider panel and the second end panel. The base is further structured to be selectively collapsible between a closed position with the first end panel, the second end panel, the first divider panel, the second divider panel and the center divider panel in close face-to-face proximity with each other, and an open position with the first end panel, the second end panel, the first divider panel, the second divider panel and the center divider panel being spaced apart. The first end panel is moveable between a first angular orientation substantially parallel to the first divider panel and a second angular orientation inclined substantially perpendicular to the first divider panel.

For example, the first end panel will generally be placed in the first orientation when the caddy is to receive a grocery bag or other articles between the substantially parallel and spaced apart first end panel and the first divider panel.

On the other hand, the base will generally be in the second orientation when the caddy is not going to hold a grocery bag in the compartment between the first end panel and the first divider panel. In the second angular orientation, the inclined rigid first panel can help prevent the caddy from tipping over by providing added support to the first divider panel and/or by providing a longer effective base for the caddy. In preferred embodiments, the first end panel will be put in the second angular orientation by being rotated 90 degrees so that it is lying along the bottom plane of the caddy.

Additional positioning of the device is contemplated. For example, in additional embodiments, the center divider panel is composed of two rigid panels arranged substantially parallel to one another such that each of the two panels is movable between a first angular orientation substantially parallel to the first and second divider panels and a second angular orientation inclined substantially perpendicular to the first and second divider panels. When placed in the second angular orientation, an enlarged compartment in the device is formed, suitable for containing a cooler bag, for example.

In additional embodiments, the first divider panel and second divider panel are movable between a first angular orientation substantially parallel to the center divider panel and a second angular orientation inclined substantially perpendicular to the center divider panel. When placed in this position, the device forms a “W” shape, as viewed from a side. This positioning provides for additional storage and holding capability of different sizes and types of articles.

According to a second aspect of the present invention, a device is provided for organizing or holding shopping articles in an upright position. The device includes a first end panel having a first side edge, a second side edge and a bottom edge, a second end panel having a first side edge, a second side edge and a bottom edge, a center divider panel having two substantially parallel divider members, each having a first side edge, a second side edge and a bottom edge, and a pliable base.

The pliable base defines two side panels and a bottom panel connected to at least one side edge of the end panels and center divider panel and structured to constrain the first end panel, the second end panel, and the center divider panel to each other so that the first divider panel is located substantially between the first end panel and the second end panel, with the base being collapsible between an open position with the first end panel, the second end panel and the center divider panel being spaced apart and substantially parallel to each other, and a closed position with the first end panel, the second end panel and the center divider panel being in a close substantially face-to-face adjacency or engagement and substantially parallel to each other.

As used herein, “spaced apart” means spaced away from each other so that a reasonably-sized grocery bag can fit in between successive panels. As used herein, “in close proximity” means either contiguous or at least close enough together so that a reasonably-sized grocery bag cannot fit between successive panels.

### BRIEF DESCRIPTION OF THE DRAWINGS

The nature, goals, and advantages of the invention will become more apparent to those skilled in the art after considering the following detailed description when read in connection with the accompanying drawing, illustrating by way of examples the principles of the invention, in which like reference numerals identify like elements throughout, wherein:

FIG. 1 is a perspective view of a fully open shopping caddy system according to the present invention;

FIG. 2 is a perspective view showing an additional arrangement of the shopping caddy system of FIG. 1 with the center divider panels rotated to be inclined relative to the divider panels;

FIG. 3 is a is a perspective view showing an additional arrangement of the shopping caddy system of FIG. 1 with both end panels rotated to be inclined relative to the divider panels;

FIG. 4 is a is a perspective view showing an additional arrangement of the shopping caddy system of FIG. 1 with both end panels rotated to be inclined relative to the divider panels and with the center divider panels rotated to be inclined relative to the divider panels;

FIG. 5 is a perspective view showing an additional arrangement of the shopping caddy system of FIG. 4 with both end panels in a raised position;

FIG. 6 is a perspective view showing an additional arrangement of the shopping caddy system of FIG. 3 with both end panels in a raised position;

FIG. 7 is a is a perspective view showing an additional arrangement of the shopping caddy system of FIG. 1 in the “W” configuration;

FIG. 8 is a side view of the shopping caddy of FIG. 1 in the fully open position;

FIG. 9 is a side view of the shopping caddy of FIG. 1 in a partially collapsed position;

FIG. 10 is a side view of the shopping caddy of FIG. 1 when the caddy has almost reached the fully collapsed position;

FIG. 11 is a bottom view of the shopping caddy in the fully open position;

FIG. 12 is a bottom view of the shopping caddy in the partially collapsed position of FIG. 7;

FIG. 13 is a perspective view of the shopping caddy system in a collapsed and secured position; and

FIG. 14 is a perspective view of the shopping caddy system of FIG. 1 with both end panels rotated to be inclined relative to the divider panels and a shopping bag partially placed in one of the center compartments.

FIG. 15A shows a perspective view of another preferred embodiment of the disclosed caddy device and system which is configurable from one to three compartments and is adapted to receive a removable thermally insulated cooler section.

FIG. 15B depicts the embodiment of FIG. 15A showing a two compartment configuration with one compartment sized to accommodate insertion of the insulated section.

FIG. 15C depicts the device of FIG. 15A wherein first and second dividers have been positioned to form one large unit.

FIG. 15D shows the device of FIG. 15A wherein one end compartment has been secured to a divider thereby configuring the device to a two compartment configuration.

FIG. 15E depicts a second single compartment configuration substantially a third the size of the configuration of FIG. 15B.

FIG. 15F is a perspective view of the bottom of the device showing means for fastening and pads.

FIG. 15G depicts a surface mount component which may be optionally employed to provide for easy engagement with the bottom of the device shown in FIG. 15F or other embodiments of the device described and shown herein and which can optionally provide a thermal element to communicate cold or heat to an overiding caddy during transport.

### DESCRIPTION OF THE PREFERRED EMBODIMENTS

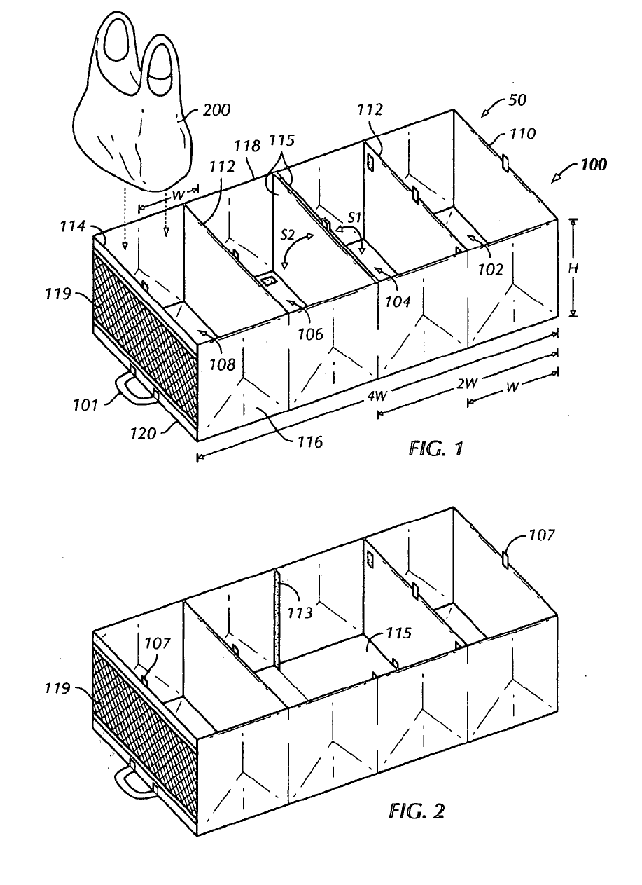

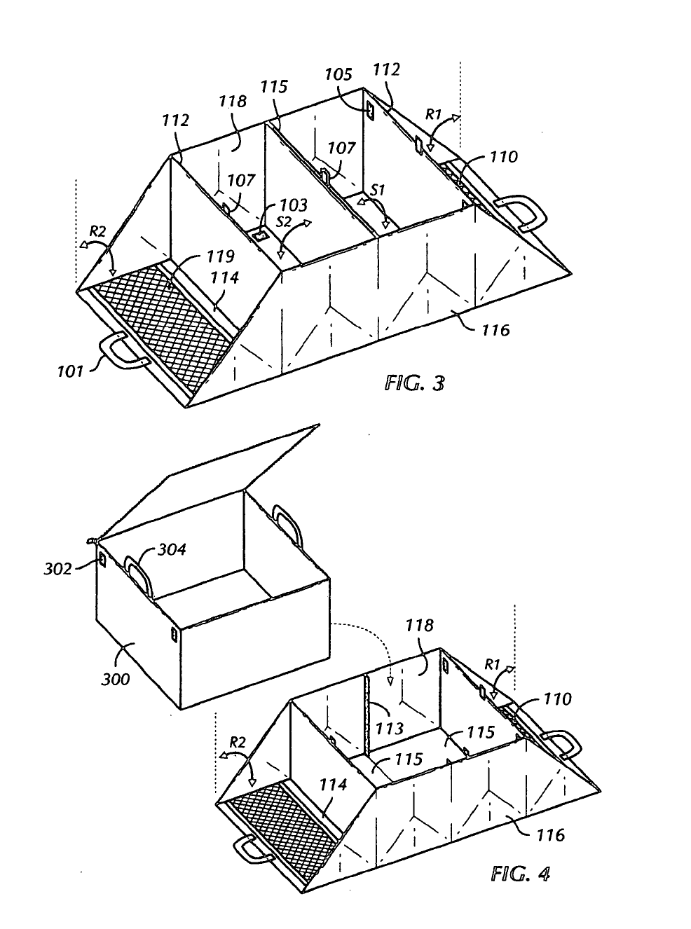

FIGS. 1 to 15G show a shopping caddy and organizer system 50 in accordance with the invention, including a shopping caddy 100 and a shopping bag 200. Caddy 100 holds the bags upright, for example, in the trunk of a car or on the floor of a van. Although this preferred embodiment caddy 100 is not fixed in the vehicle, shopping bag 200 will generally be restrained from sliding around or tipping when it is constrained through caddy 100 as compared with such a bag placed separately in a car. While the caddy system is particularly adapted for holding shopping articles, it may have many other uses such as shipping and storage of other articles.

As explained below in more detail, this preferred caddy 100 is advantageous because it collapses in the end-to-end direction, thereby allowing the collapsed caddy 100 to have a smaller length and width footprint than it would if collapsed in a side-to-side direction or top-to-bottom direction, which other configurations would typically result in the bottom panel being non-foldable. Also, end panels 110 and 114 can be rotated inwardly toward intermediate divider panels 112 to lie flat against the bottom panel 120 of the caddy. This feature can be used to provide a longer and more rigid base for the caddy when one or both endmost compartments are not filled with and supported by shopping bags. This is especially important because bottom panel 120 is pliable to allow for the end-to-end caddy collapsing action mentioned earlier in this paragraph.

As shown in FIG. 1, caddy 100 includes first end panel 110, two intermediate divider panels 112, center divider panels 115, second end panel 114, a first side panel 116, a second side panel 118, and a bottom panel 120. The panels 110, 112, 114, 115, 116, 118, and 120 define four rectangular compartments 102, 104, 106, 108. It is contemplated herein that by designing caddies with more or fewer intermediate divider panels 112, different numbers of compartments may be obtained. In addition, the compartments could be square shaped as well. While the compartments are shown as each being the same size as the others, that is not a requirement of the invention.

Side panels 116, 118 and bottom panel 120 are preferably made of pliable nylon fabric. End panels 110, 114 and intermediate divider panels 112 and center divider panel 115 are formed as somewhat rigid boards (preferably made of plastic, rubber or hardboard-like condensed cardboard, or the like) encased in a suitable pliable sheet such as nylon. The “somewhat” rigid boards are preferably more flexible and elastic than a cardboard box or the wire mesh of a typical shopping cart, but much more rigid than cloth. The desired balance of rigidity and flexibility would be something like that provided by the sole of a light duty shoe. This intermediate degree of rigidity provides good support for bags in caddy 100, while allowing plenty of give to prevent breakage of the panels. As used herein, the word “rigid” will be used to generically denote the preferable intermediate degree of rigidity described above, as well as higher degrees of rigidity.

The nylon casing of the rigid boards of panels 110, 112, 114, and 115 allows the panels to be sewn to the nylon side and bottom panels 116, 118, 120 and provides the caddy with an attractive, uniform color and texture. Of course, materials other than nylon could be employed for the fabric casings. It is not essential to the invention that there be any fabric casing, but it is part of the preferred embodiment.

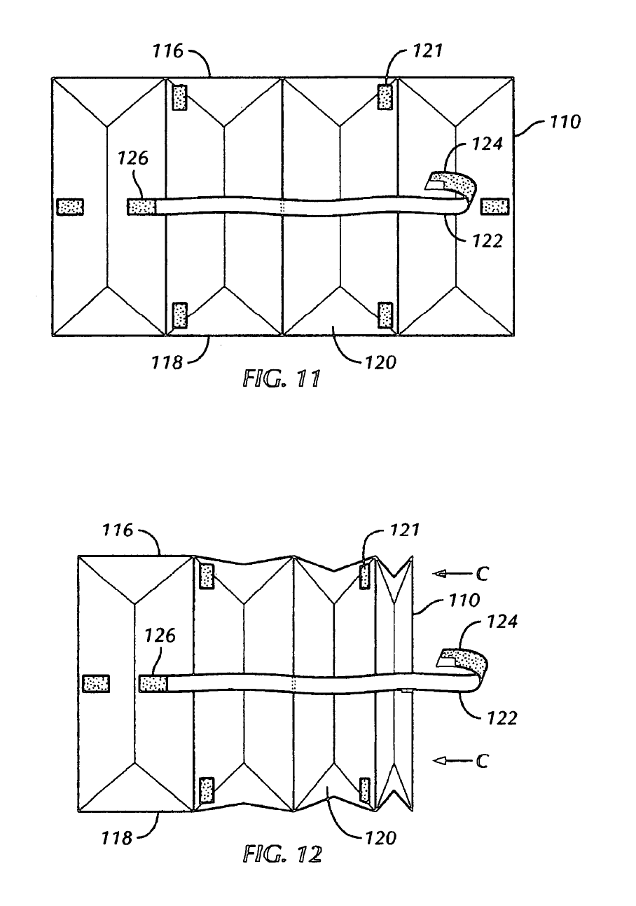

As seen in FIG. 11, caddy 100 further includes a strap 122 with first a hook and loop fastening means such as that sold under the trademark Velcro.RTM. End 126 and end 124 can be secured together, for example. A portion of strap 122 is sewn to bottom panel 120 to hold it in place. The strap is long enough to hold caddy 100 in a collapsed and stacked state (see FIG. 11). Because of the end-to-end collapsing action of the caddy, the stack held by strap 122 also has a small footprint. Due to the careful dimensioning of the caddy in the stacked state it is nearly flush along its edges. This makes for a compact, attractive stack which is easy to carry during shopping excursions. Because caddy system 50 forms such a nice stack, strap 122 is a very useful adjunct of the preferred caddy system 50, but it is not an essential element of the invention.

Because the ends 124, 126 are formed with complementary Velcro portions, they are detachably attachable so that the length of the loop circumscribed by strap 122 can be varied depending on the height of the stack, which in turn depends upon whether the user chooses to secure bags, for example, in addition to the stack. Of course, other adjustable attachably detachable structures could be used, such as buttons, snaps, magnets, tieable cords, and so on.

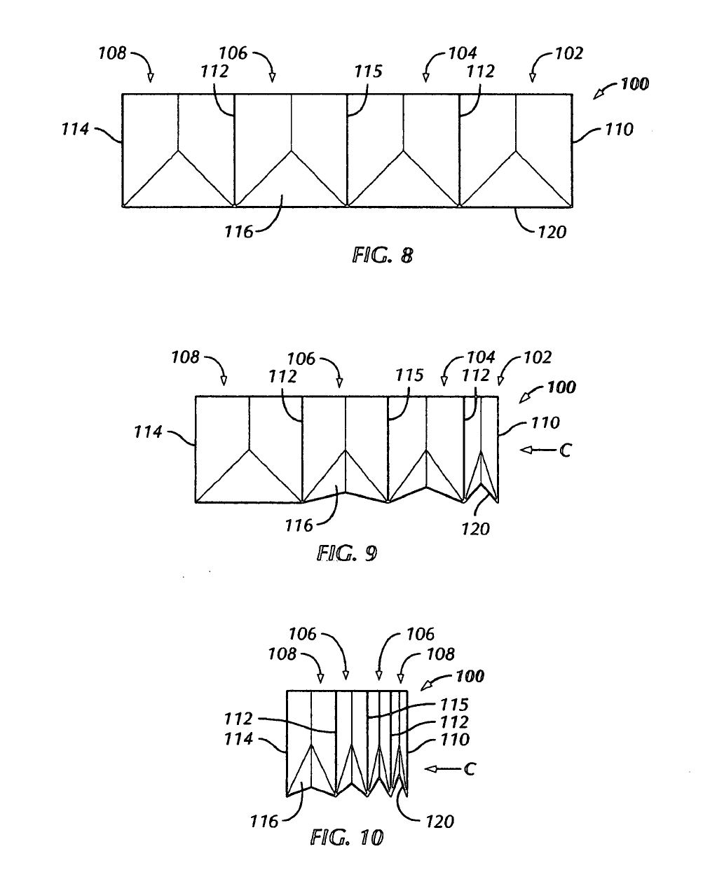

At least some conventional caddies are made to be mounted to a car trunk. In these conventional caddies, the mounted caddy prevents tipping or translation of the caddy and its bags. In a preferred embodiment, no means are provided to mount caddy 100 to a floor or surface, so the manner in which unmounted caddy 100 prevents motion and tipping of the grocery bags will be described in some detail. However, as seen in FIGS. 9 and 10, caddy 100 alternatively has non-skid feet 121, which aid in keeping the device fixed and upright, especially in a moving vehicle. However, in other embodiments of the invention, it is contemplated that the caddy is mounted or secured to a vehicle. For example, the caddy could be mounted to the floor of the trunk, or it could be integrated with the rear portion of the back seat of the vehicle.

First, with respect to tipping, when a bag is used without the caddy, its weight is distributed over a fairly small width W (see FIG. 1). Further, the center of gravity of a loaded bag is likely to not be close to the bottom of the bag. When forces tend to rotate the bag about its bottom edge, tending to thereby tilt up the base of the bag about one of its bottom edges, the countervailing weight of the bag will act only along a fairly short moment arm W and will only produce a limited moment to resist this tipping.

On the other hand, when a bag is constrained by caddy 100 in compartment 104 or 106, for example, to act as a unit, the weight of the bag acts along longer moment arm 2W so that the weight of the bag produces a much greater moment to resist the tipping forces. Similarly, if all four compartments 102, 104, 106, 108 are filled with bags, the unit has a base which is 4 W long. This long effective base is very resistant to tipping due to its length.

Second, with respect to sliding or translation of the bags, the constraint provided by caddy 100 effectively prevents such translation of either the bags or the caddy itself. This is because the combined weight of bags result in greater static frictional forces that must be overcome before caddy 100 will move along the surface upon which it rests. It is also noted that some limited degree of translation of the caddy, for example, within the trunk of a moving car, will generally not cause damage to or tumbling of the groceries.

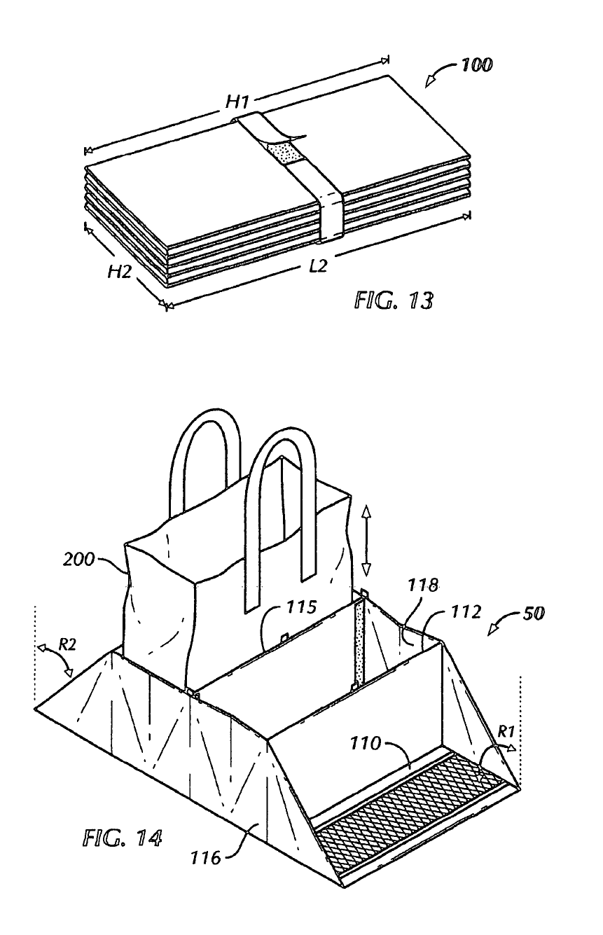

While the preferred caddy does not have mounting structures, it is noted that caddy 100 could be modified to include mounting structures. As stated above, in a preferred embodiment herein, caddy 100 has anti-skid pads 121 (FIGS. 11 and 12) on bottom 120 to further prevent movement during transport.

As mentioned above, caddy 100 collapses in the end-to-end direction. This is shown in detail in FIGS. 9, 10, 11, and 12. FIG. 8 shows caddy 100 in a fully open position with panels 110, 112, 114, and 115 being spaced apart to form compartments 102, 104, 106, 108. FIG. 9 shows caddy 100 in a partially closed position with first end panel 110 moved in direction C toward the opposite second end panel 114. Pliable fabric side panels 116, 118 fold inwardly to allow this collapsing motion.

FIG. 10 shows a further partially collapsed position, with first end panel 110 and each of intermediate divider panels 112 and center divider panel 115 moved in direction C toward close proximity with each other and with second end panel 114. FIG. 13 shows the caddy in the collapsed position with panels 110, 112, 114, and 115 being in such close proximity that they actually come into contact with each other to form a very compact stack. Alternatively, the panels may be brought into close proximity without quite touching each other.

This end-to-end collapsing brings out one of the powerful advantages of the present invention, which is the balance between sturdiness, support and collapsibility of caddy 100. More specifically, side panels 116, 118 and bottom panel 120 are large in size. However, these large panels are made of pliable material such as nylon fabric so that they fold up and do not significantly increase the size of the caddy in the collapsed position. Materials other than nylon could be used, as could heavier materials such as canvas. On the other hand, rigid, parallel panels 110, 112, 114, and 115 provide good support for bags and allow the caddy to hold its shape when open and empty. Therefore, the end-to-end collapsing feature of caddy 100 allows several somewhat conflicting design objectives to be simultaneously accommodated.

As shown in FIGS. 3, 4 and 14, another feature of caddy 100 is the folding down action of end panels 110 and 114. First end panel 110 can be rotated in direction R1 down and inward relative to intermediate divider panels 112. As shown in FIGS. 3, 4 and 14, first end panel 110 has been rotated all the way down into a position lying along bottom panel 120, so that first end panel 110 is substantially perpendicular to intermediate divider panels 112. Second end panel 114 can also be rotated in direction R2 down and inward relative to intermediate divider panels 112.

In the preferred caddy 100, the end panels can be rotated because they are sewn to pliable bottom panel 120 along their axis of rotation, and because pliable side panels 116, 118 collapse and fold to allow the rotational motion. It is noted that such rotational motion could be provided for in other ways, such as by a hinge and other hardware, which would allow rotational movement between the end panels and the side and bottom panels of caddy 100.

First end panel can be snugly folded all the way down because height H2 (FIG. 13) of first end panel 110 is approximately equal to width W of compartment 102. By approximately matching these dimensions, first panel 110 can be held in the folded down orientation by holding a portion of the bottom panel in tension between the seam joining intermediate divider panel 112 to bottom panel 120 and the seam joining first end panel 110 to bottom panel 120. This tension detachably engages first end panel 110 in the folded down position so that it does not pop back up, for example, under the influence of small mechanical shocks.

When the first compartment 102 is not holding a bag, first end panel 110 is preferably rotated all the way down to lie flat against bottom panel 120 in order to keep the effective width of the base of the caddy in its longer condition and thereby to help prevent tipping in the counter-R1 direction (see FIG. 14). Similarly, second end panel 114 can be folded down to maintain the effective width of the base longer and thereby prevent tipping in the counter-R2 direction. In this way, tipping can be minimized even when caddy 100 holds only one or two bags.

Although end panels 110, 114 of preferred caddy 100 can be folded to lie down against bottom panel 120, the end panels could be alternatively dimensioned relative to the width of the compartments 102, 108 so that they can be only partially rotated downward before physical interference with divider panels 112 blocks further rotation. In this alternative embodiment, the end panels would act as sort of a flying buttress, both supporting intermediate divider panels in the upright position while also helping to prevent tipping of the entire caddy by increasing the effective length of the base.

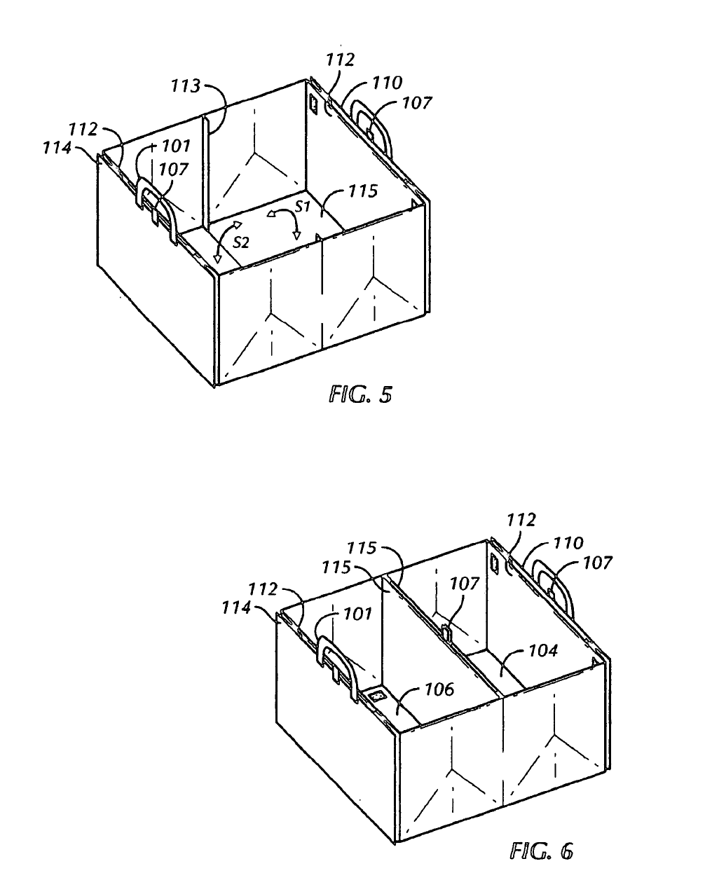

FIG. 5 shows an alternate arrangement of the embodiment of the invention shown in FIG. 4. As shown in place in FIG. 4, end panel 114, in conjunction with the portion of bottom panel 120 that it covers, can be folded upward relative to intermediate panel 112. Side panels 116 and 118 are tucked inward during the folding up process so that they are placed neatly between end panel 114 and intermediate panel 112. Then using Velcro strap 107, the end panel is secured in close relation to intermediate panel 112. For the other end, end panel 110 is positioned similarly. This arrangement then produces and open box configuration with a flat bottom portion and double-thickness ends. Handles 101 are used for transporting the open box. The embodiment of FIG. 5 is particularly useful for larger items that would not otherwise fit within one compartment and also which are relatively heavy and require lifting with handles for convenience.

FIG. 6 shows an alternate arrangement of the embodiment of the invention according to FIG. 5. In this arrangement, as compared to the arrangement of FIG. 5, center divider panels 115 have been raised to the upright position, thereby forming two compartments. These dividers can be secured together with straps 107.

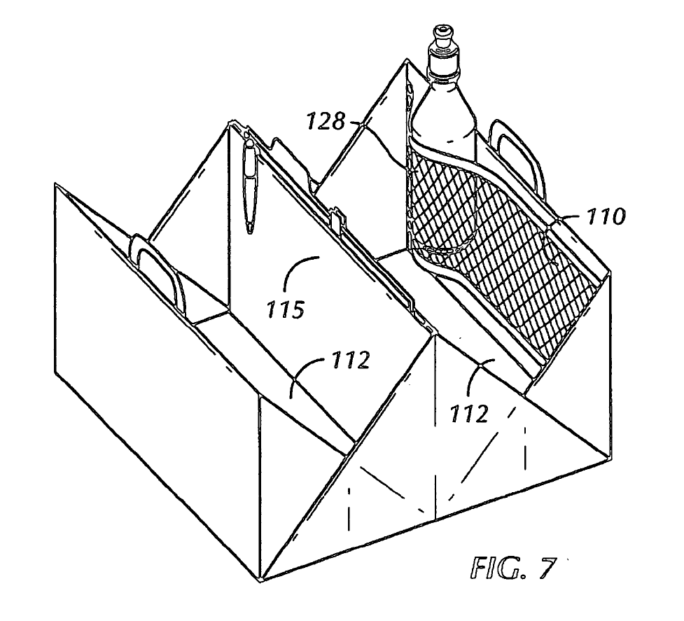

FIG. 7 shows an alternate position of the present invention, suitable for placement on a car seat, or between seats in a van, for example. This configuration is generally referred to herein as the “W” shape, because from the side, it forms the shape of the letter “W.” The W shape is achieved by first folding end panels 110 and 114 inward relative to divider panels 112. As described above, end panels 110 and 114 will be inclined to be substantially perpendicular to divider panels 112. Next, divider panels 112 are also folded down to be inclined substantially perpendicular to center divider panel 115. The first divider panel and second divider panel are movable between a first angular orientation substantially parallel to the center divider panel and a second angular orientation inclined substantially perpendicular to the center divider panel.

Folding down the divider panels causes the end panels to rotate upward, with handle 101 moving to the top of the device. Divider panels 112 are held in the downward position primarily by an interference fit with the side panels and the center divider panel. In addition, hook and loop engagement means 103 and 105 ensure that the divider panels stay in position.

Also as shown in FIG. 7, a water bottle, for example, may be placed in mesh pocket 128, and will be retained within the perimeter of the device. This is particularly advantageous for securing the bottle. In case the bottle becomes unrestrained by the mesh, it will still be held within the confines of the device. In addition, various other personal items, such as a pen or a file folder may be placed between center divider panels 115.

Center divider panel 115 is preferably composed of two substantially rigid panel members, arranged parallel and hinged at the bottom of the device. As shown in FIG. 4, hook and loop fastening means 113 secures the center divider panels in the upright position. However, by disengaging this fastening means, the center divider panels can be rotated downward in the S1 and S2 directions (FIG. 3) to the bottom of the device to be substantially parallel thereto. Tabs 107 located on a top edge of the center divider panels aid in the S1 and S2 rotations. Further hoop and loop fastening means 105 on panel 112 and 103 on bottom panel 120 engage with each other, thereby securing panels 112 to the bottom. This feature is particularly advantageous in holding the W configuration shown in FIG. 7. This thereby forms an enlarged compartment, suitable for larger items, such as container 300 (FIG. 4).

In further embodiments of the invention, another container, such as a cooler bag, may be provided and sized for engagement in the enlarged compartment formed by folding down the center divider panels. Alternatively, other containers having other sizes and shapes may be provided to be retained in any of the compartments of the organizer. As shown in FIG. 4, cooler bag 300 is approximately square in shape and is sized to engage snugly within the enlarged center compartment. Handles 304 allow for convenient placement and removal of the cooler bag from the enlarged compartment. Although not shown in the drawing, it is also contemplated herein that the cooler bag may have a zippered or otherwise closeable cover, may be substantially waterproof, and may be constructed of material that reduces the transmission of heat or cold, thereby keeping items therein either cold or hot, depending on the particular application. Cooler bag 300 may also have Velcro patches 302 on one or more exterior surfaces thereof, suitably arranged for engagement with complementary Velcro patches on the divider panels.

In additional embodiments of the invention, the device includes a first end panel having a first side edge, a second side edge and a bottom edge, a second end panel having a first side edge, a second side edge and a bottom edge, a center divider panel having two substantially parallel divider members, each having a first side edge, a second side edge and a bottom edge, and a pliable base. A pliable base is also provided. It will be appreciated that in this embodiment, the first and second divider panels 112 found in previous embodiments, are not present. Also, any type of fasteners, such as clips, clamps, staples, or the like, could be used in place of the hook and loop fasteners shown and described.

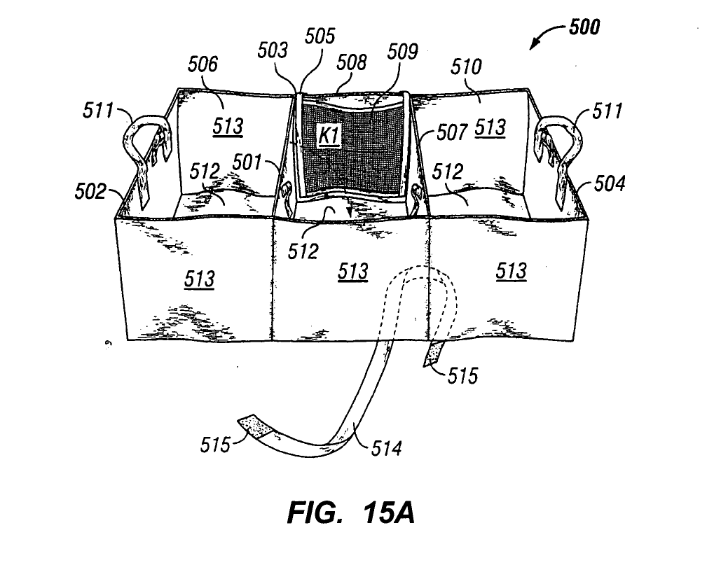

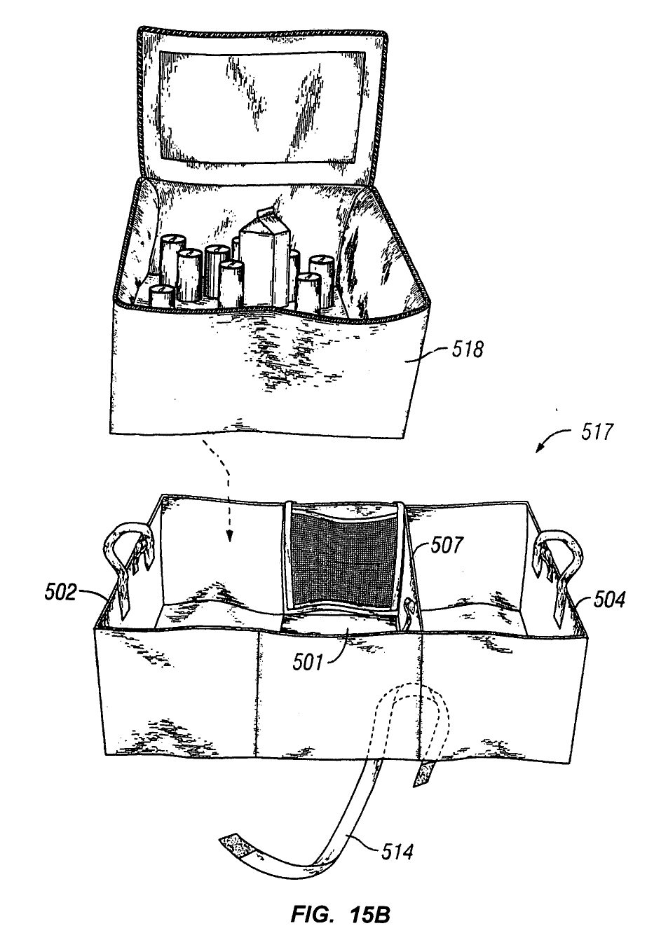

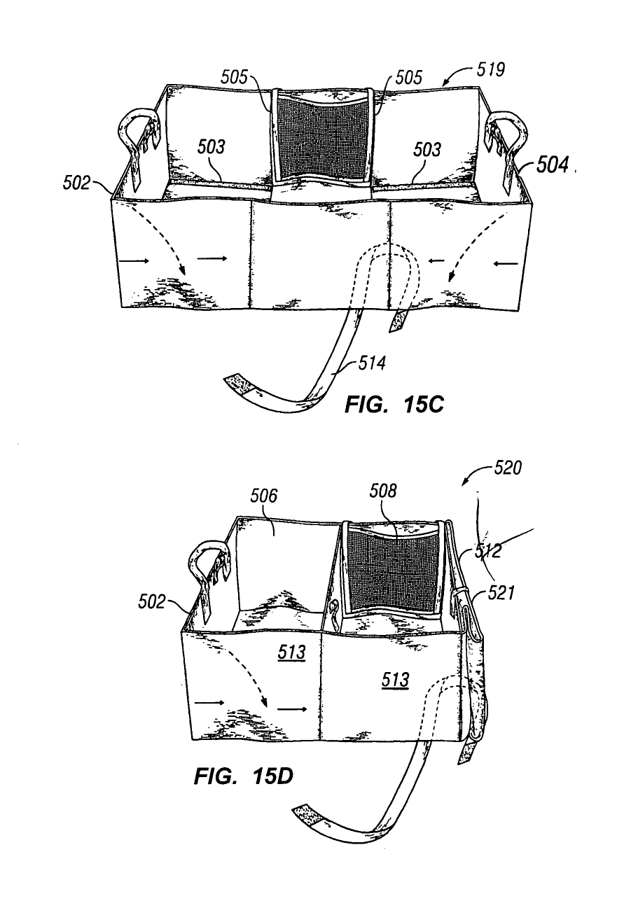

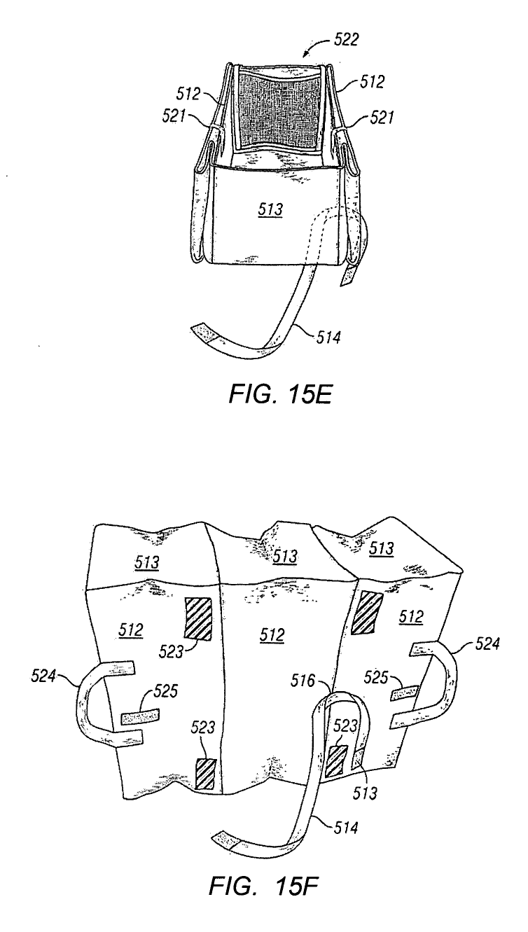

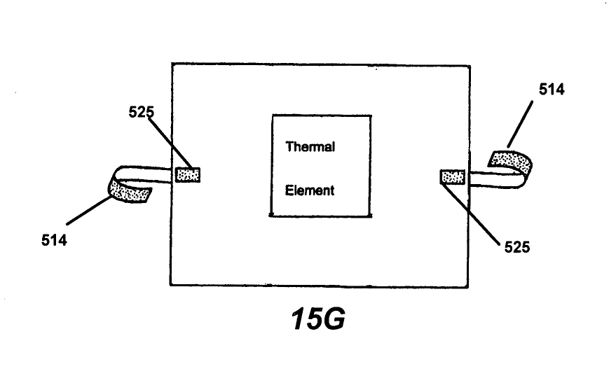

A particularly preferred mode of the device herein is shown as an alternate compartment embodiment 500 in FIGS. 15A-F. As shown in FIG. 15A, this embodiment is easily adjustable to a wide variety of configuration by the user having from one to three individual compartments. This alternate compartment embodiment 500 is also adapted for engagement of a thermally insulating cooler unit 518 making it especially useful for transport of cold or hot food.

Featured in this alternate compartment embodiment 500 of the invention herein is a first divider 501 and second divider 507 which are rotatable along their engagement to the bottom 512 in two directions to provide a means to define an array of compartment sizes and shapes by simply folding the dividers to different positions. As shown in FIG. 15A, there is a configuration of a preferred embodiment of the alterative compartment embodiment 500 which comprises a first compartment 506, a center or second compartment 508 and a third compartment 510. The size and number of these compartments are determined by the positioning of the first divider 501 and second divider 507, which both communicate between a pair of sidewalls 513. The three compartment configuration is determined by the vertical positioning of the first and second dividers 501 and 507 a distance from each other and from a first end 502 and second end 504 respectively.

The dividers are rotatable in their engagement to the bottom panel 512 and may be held in the substantially vertical position in a removable engagement by divider fastening means 503 which as depicted is hook and loop fabric on both the dividers, and the side panels 513. The hook and loop fabric on the side panels 513 is positioned to contact and engage the opposite hook and loop fabric on an edge of the dividers and hold them substantially perpendicular to the bottom panel 512 when so engaged. Each of the formed compartments 506, 508, and 510 is thus accessible from a top aperture and defined by the dividers and ends rising from a bottom panel 512. The formed compartments in this fashion are generally rectangular in dimension and will easily receive and restrain cargo through their respective top apertures opposite the bottom panel 512. As those skilled in the art will no doubt realize, the compartments can be made larger or smaller depending on the positioning of the dividers and length of the sidewalls 513 and ends 502 and 504 and all such changes or adaptations for size are considered within the scope of this invention.

As seen in all the FIGS. 15A-D, a plurality of handles 511 are provided to aid in the lifting and transport of the compartment embodiment 500. A first pair of handles 511 are engaged along the first end 502 and second end 504 and can be employed by a user to carry the compartment embodiment 500 when deployed. A second pair of handles 524, as shown in FIG. 15F, are engaged to the bottom panel 512 adjacent to the ends 502 and 504 and provide great utility when the device is reconfigured. The two end panels 502 and 504 are in the preferred mode, substantially rigid in nature having an internal stiffener.

Also depicted in FIG. 15A is a preferred mode with a pocket 509 of a mesh fabric located in the second compartment 508 along an inside face of the side panel 513. Of course those skilled in the art will realize that a plurality of pockets 509 may be employed or the depicted pocket 509 may be placed in other locations and such are anticipated in the scope of this invention. Thus one or a plurality of pockets 509 when included provides sub-compartments to the individual compartments and using mesh allows a visual identification of the contents.

In FIGS. 15A and 15F there is also depicted a strap 514 which is engaged at one point to the bottom surface 512. This strap 514 has means for fastening the ends of the strap together which as pictured is hook and loop fabric with one type engageable to the other on opposite ends of the strap 514. Of course other means to engage the strap ends can be employed such as snaps, buttons, hooks or clips.

An especially preferred mode of this mode of the invention is depicted in FIG. 15B. The device is shown in a two compartment configuration with one compartment larger than the other to accommodate cargo of larger dimension. However, as shown, a cooler unit 518 component adapted in size for engagement into one of the two compartments is engageable to provide transport of cold items. This configuration is achieved by rotating the first divider 501 to a position adjacent to and parallel to the bottom panel 512. This forms one compartment larger than the other and of a size to accommodate the cooler unit 518 which is dimensioned for engagement in the formed compartment. Of course either of the first or second dividers may be rotated to the horizontal position to achieve this configuration.

The versatility of this mode of the device is shown in a single compartment configuration 519 depicted in FIG. 15C. This configuration yields one very large compartment and is achieved by rotating both the first and second dividers 501 and 507, to horizontal positions adjacent to the bottom panel 512. The dividers 501 and 507 are rotated away from each other normally to their horizontal positions. In this formation, a means for support of both ends of this alternate compartment embodiment 500 is provided since both the dividers 501 and 507 and the now perpendicular ends 502 and 504, are substantially rigid.

In FIG. 15D there is shown another two-compartment mode of the device which is achieved by collapsing the third compartment 510 shown in FIG. 15A. To achieve this compact format the second end 504 is laterally translated to a position adjacent to the second divider 507 and maintained there by the securing means 521 shown as a strap which as noted has hook or loop fabric on it with the other of the hook or loop fabric on a mounting position. Another manner to achieve this compact mode is to rotate both end panels 502 and 504 toward the center of the device to a horizontal position and then rotate the bottom panel 512 portions under the end panels to a vertical position. Securement in this manner of compaction is provided by the securing means engaging a cooperating fastener 525 on the bottom panel 512 shown in FIG. 15F.

As shown by the direction arrows in FIGS. 15C and 15E, the first end 502 and the second end 504 have two modes for reconfiguration with this stiff walled construction. In one configuration mode the ends may be translated along the horizontal arrow of direction to a position adjacent to the first divider 501 and the second divider 507 and secured in that position by the end securing means 521 which in this case is a strap of hook and loop fabric engaged over the top edge as shown in FIG. 15E. In a second reconfiguration mode, the first end 502 and second end 504 may be rotated along their attachment to the bottom panel 512 to a configuration similar to that of FIG. 4. In this configuration the top edges of both the first end 502 and second end 504 (opposite their attachment to the bottom panel) are positioned proximate to the bottom edges of the first divider 501 and second divider 507. Much like the configuration of FIG. 4, the stiff flattened first end 502 and second end 504 being rotated adjacent and parallel to the bottom panel 512, provide a lateral support to the center compartment formed in between the first and second dividers.

Using the provided double mode of reconfiguration of the first and second ends 502 and 504, should a two compartment container be desirable, then one end would be laterally translated adjacent to a divider such as depicted in FIG. 15D, where the second end 504 is positioned parallel to and adjacent to the second divider 507 and secured in that position by the end securing means 521 of a strap and mount of hook and loop fabric.

Or, much like FIG. 6 of the device herein, both the first end 502 and the second end 504 may be rotated in their engagement along the bottom panel 512 to a horizontal position adjacent to the bottom panel 512. Then, the bottom panel 512 underneath the stiff first and second ends, is then rotated such that the handles 524, will be positioned adjacent to the top edge of the dividers 501 and 507, and the first end 502 and second end 504 respectively are parallel to the first divider 501 and second divider 507 respectively. This will leave one cavity for carrying material within and the bottom handles 524 adjacent to the top edge of the reconfigured device for the user to employ in carrying it.

In FIG. 15E, a compacted mode and single compartment configuration 522 of the caddy device, is achieved by lateral translation of both the first end 502 and second end 504 to a position adjacent to the first divider 501 and second divider 507. Once adjacent, the securing means 521 is employed by engaging the two cooperating fastening components such as the noted hook fabric and loop fabric in two positions.

Finally, in FIG. 15F, there is depicted a bottom perspective view of this alternative compartment embodiment 500 of the disclosed device. The strap 514 is shown engaged to the bottom panel 512 at a securing location 516. Also shown are the bottom handles 524 which relocate to the top of the device when either of the two ends are rotated the 180 degrees to compact a compartment. The bottom handles, in addition to relocating to the top of the device, also provide a means for hand engagement by the user to the bottom panel 512 which may be preferable when carrying a heavy load. Skid pads 523 are also shown and provide a means for gripping the support surface on which the device might rest.

The handles 511 and 524 provide a further important function to the device when it is traveling in a vehicle. The aperture between each handle provides a means for engagement of a car seat belt (not shown) as a means to secure the device to its support surface and prevent it from moving during hard turns or acceleration or stops. Additionally, securement through both handles 511 and 524 on either or both sides provides a double engagement to the support surface which may be preferable with a heavy load.

The Multi-Positionable Caddy and Organizer System device, shown in the drawings and described in detail herein, consists of arrangements of elements of particular construction, and configuration for illustrating preferred embodiments of structure and method of operation of the present invention. It is to be understood, however, that elements of different construction and configuration and different steps and process procedures and other arrangements thereof, other than those illustrated and described, may be employed for providing the apparatus herein and still be within the scope of this invention.

As such, while the present invention has been described herein with reference to particular embodiments thereof, a wide latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A device for organizing or holding articles during transport, comprising:
a rigid first end panel and rigid second end panel;
at least one rigid divider panel positioned between said first and said second end panel;
a pliable base secured to bottom edges of said first and second end panels and to each said divider panel;
a plurality of pliable side panels each connecting at bottom edges to said pliable base and communicating between said end panels; and,
wherein said pliable base is selectively configurable between a collapsed state and expanded state.

2. The device of claim 1 further comprising:
at least one said rigid divider panel being selectively moveable between a first orientation substantially vertical and perpendicular to said pliable base, and a second orientation adjacent to and substantially parallel to said pliable base.

3. The device of claim 2 further comprising:
fastener means for securing said rigid divider panel to said side panels to maintain said rigid divider panel in either of said first or second orientation.

4. The device of claim 1 further comprising:
a center divider panel between said first and second end panels;
said center divider panel formed of two separable said rigid panels; and
means to engage said first and second end panels to each other to form said center divider panel.

5. The device of claim 1 further comprising:
a center divider panel, said center divider panel formed of two separate of said rigid divider panels;
said separate rigid panels positioned substantially parallel to each other and rotationally engaged at a first edge with said pliable base;
each of said two panels individually moveable between a first position substantially vertical and perpendicular to said pliable base and in contact with each other, and a second position substantially horizontal and adjacent to said pliable base; and
means for securing said two rigid divider panels to said side panels to maintain said rigid divider panels in said first position.

6. The device of claim 5 additionally comprising:
said center panels in said first position defining one side of two compartments situated in between said first and second end panels and said side panels; and
a single enlarged compartment defined by said first and second end panels and said side panels when said center panels are situated in said second position.

7. The device of claim 6 further comprising:
a cooler bag, said cooler bag having an exterior surface dimensioned for an engagement within said enlarged compartment.

8. The device of claim 7 wherein said engagement of said cooler bag is a removable engagement.

9. The device of claim 7 additionally comprising:
said cooler bag being substantially waterproof; and
said cooler bag having means for thermal insulation.

10. A device for holding articles in a vehicle, comprising:
a rigid first end panel having a lower edge and opposite distal edge and rigid second end panel having a lower edge and an opposite distal edge, each of said first end panel and second end panel engaged at a respective said lower edge, to one of two opposite ends of a pliable base;
a rigid first divider panel rotationally engaged to said base at a position between said first and said second end panels;
a rigid second divider panel rotationally engaged to said base at a second position between said first rigid divider panel and said second end panel;
a plurality of pliable side panels each connecting at bottom edges to said pliable base and each connecting at respective end edges with said first and second end panels;
a main cavity defined by the area between said first and second end panels and said side panels;
said first divider panel having a first orientation substantially perpendicular to said base and a second orientation substantially parallel and in contact with said base;
said second divider panel having a first position substantially perpendicular to said base and having a second position substantially parallel to and in contact with said base;
means to engage said first divider panel to at least on of said side panels and maintain it in said first orientation; and
means to engage said second divider panel to at least one of said side panels and maintain it in said first orientation, whereby said main cavity is divisible into multiple compartments through a configuring of said first divider panel to one of said first or second orientations or a second configuring of said second divider panel to one of said first or second positions.

11. The device for holding articles in a vehicle of claim 10 further comprising:
said main cavity configurable to three said multiple compartments by an engagement of said first divider panel in said first orientation and said second divider panel is in said first position.

12. The device for holding articles in a vehicle of claim 11 further comprising:
said multiple compartments being of substantially equal size.

13. The device for holding articles in a vehicle of claim 10 further comprising:
said main cavity configurable to two said multiple compartments by a positioning of one of said first divider panel or said second divider panel in a respective first orientation or first position, and the other of said first divider panel and said second divider panel is in a respective second orientation or second position.

14. The device for holding articles in a vehicle of claim 13 further comprising:
a first compartment of said two multiple compartments being substantially twice the size of the other of said two compartments.

15. The device for holding articles in a vehicle of claim 12 further comprising:
said device being selectively configurable between a collapsed state with said first end panel adjacent to said first divider and said first divider adjacent to said second divider and said second divider adjacent to said second end panel, and in contact with said first divider which is in contact with said second divider with a concurrent collapsed folding of said pliable base, or an enlarged state in which said pliable base is in a planar state and defining a respective distance between first end panel from said first divider and said first divider from said second divider and said second divider from said second end panel.

16. The device for holding articles in a vehicle of claim 16 further comprising:
a strap having two ends engaged to said pliable base;
means for removable engagement of said two ends to each other in a connected position; and
said strap in said connected position providing means to maintain said device in said collapsed state.

17. The device for holding articles in a vehicle of claim 10 further comprising:
a first pair of handles, one each of said first pair of handles engaged adjacent to a respective said distal edge of a respective one of said end panels, said first pair of handles having respective apertures therein providing a first means for holding said device in a grip of the hands of a user.

18. The device for holding articles in a vehicle of claim 17 further comprising:
a second pair of handles, one each of said second pair of handles engaged to said pliable base adjacent to a respective said bottom edge of a respective one of said end panels; and
said second pair of handles having an extended position extending substantially parallel to said base with an aperture in each respective handle extending away from said base and extending past said end panels to thereby provide a second means for holding in a grip said device in the hands of a user.

19. The device for holding articles in a vehicle of claim 18 further comprising:
said apertures of said first pair of handles and said apertures of said second pair of handles providing a means for engagement of a seatbelt of said vehicle therethrough;
said seatbelt engaged through any of said apertures providing means to maintain said device stationary upon an underlying support surface during a hard turn or rapid deacceleration of said vehicle.

20. The device for holding articles in a vehicle of claim 14 further comprising:
a cooler bag, said cooler bag having an exterior surface dimensioned for an engagement within said first compartment.

21. The device for holding articles in a vehicle of claim 18 further comprising:
said first end panel selectively positionable to an inverted position adjacent to and in contact with said first divider panel in a compressed state;
means to maintain said first divider in said compressed state;
one of said second pair of handles being positioned adjacent to an upper edge of said first divider when said first end panel is in said compressed state;
said second end panel selectively positionable to an inverted position adjacent to and in contact with said said divider panel in a collapsed state;
means to maintain said second divider in said collapsed state; and
one of said second pair of handles being positioned adjacent to an upper edge of said second divider when said second end panel is in said collapsed state.
